(19) United States
(12) Patent Application Publication
(10) Pub. No.: US 2026/0312735 A1
(43) Pub. Date: Oct. 8, 2026

(54) BIT TO CONSTELLATION MAPPING FOR FLEXIBLE SPECTRUM INTEGRATION

(71) Applicant: QUALCOMM Incorporated, San Diego, CA (US)

(72) Inventors: Pinar SEN, San Diego, CA (US); Wei YANG, San Diego, CA (US); Kianoush HOSSEINI, San Diego, CA (US); Jing JIANG, San Diego, CA (US)

(21) Appl. No.: 19/173,476

(22) Filed: Apr. 8, 2025

(51) Int. Cl. H04L 1/1829; H04L 1/00; H04W 72/0453

(52) U.S. Cl. CPC H04L 1/1861; H04L 1/0003; H04W 72/0453

(57) ABSTRACT

This disclosure provides methods, components, devices and systems for bit to constellation mapping for FSI. For example, a wireless device may communicate an indication of information for an integrated spectrum channel of a single virtual cell, where the integrated spectrum channel includes a set of sub-bands associated with different modulation orders, different ranks, or both. Thus, the wireless device may generate a single transport block (TB) based on a set of code blocks (CBs) associated with the single transport block being mapped to the set of sub-bands in accordance with a mapping configuration and may transmit the single TB via the set of sub-bands in the integrated spectrum channel. In such cases, the mapping configuration may be based on the set of sub-bands being associated with the different modulation orders, the different ranks, or both.

### TECHNICAL FIELD

This disclosure relates generally to wireless communication, and more specifically to systems, devices, methods, and techniques associated with bit to constellation mapping for flexible spectrum integration (FSI).

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a wireless device is described. The method may include communicating an indication of information for an integrated spectrum channel of a single virtual cell, the integrated spectrum channel including a set of sub-bands that are formed by combining frequency resources from multiple frequency bands, where the set of sub-bands includes at least a first sub-band associated with a first modulation order and a first rank and a second sub-band associated with a second modulation order and a second rank and transmitting a single transport block via the set of sub-bands in the integrated spectrum channel, where the single transport block is generated based on a set of code blocks associated with the single transport block being mapped to the set of sub-bands in accordance with a mapping configuration, where the mapping configuration is based on the first modulation order being different from the second modulation order, the first rank being different from the second rank, or both.

A wireless device for wireless communications is described. The wireless device may include a processing system that includes processor circuitry and memory circuitry that stores code. The processing system may be configured to cause the wireless device to communicate an indication of information for an integrated spectrum channel of a single virtual cell, the integrated spectrum channel including a set of sub-bands that are formed by combining frequency resources from multiple frequency bands, where the set of sub-bands includes at least a first sub-band associated with a first modulation order and a first rank and a second sub-band associated with a second modulation order and a second rank and transmit a single transport block via the set of sub-bands in the integrated spectrum channel, where the single transport block is generated based on a set of code blocks associated with the single transport block being mapped to the set of sub-bands in accordance with a mapping configuration, where the mapping configuration is based on the first modulation order being different from the second modulation order, the first rank being different from the second rank, or both.

Another wireless device for wireless communications is described. The wireless device may include means for communicating an indication of information for an integrated spectrum channel of a single virtual cell, the integrated spectrum channel including a set of sub-bands that are formed by combining frequency resources from multiple frequency bands, where the set of sub-bands includes at least a first sub-band associated with a first modulation order and a first rank and a second sub-band associated with a second modulation order and a second rank and means for transmitting a single transport block via the set of sub-bands in the integrated spectrum channel, where the single transport block is generated based on a set of code blocks associated with the single transport block being mapped to the set of sub-bands in accordance with a mapping configuration, where the mapping configuration is based on the first modulation order being different from the second modulation order, the first rank being different from the second rank, or both.

A non-transitory computer-readable medium storing code for wireless communications is described. The code may include instructions executable by one or more processors to communicate an indication of information for an integrated spectrum channel of a single virtual cell, the integrated spectrum channel including a set of sub-bands that are formed by combining frequency resources from multiple frequency bands, where the set of sub-bands includes at least a first sub-band associated with a first modulation order and a first rank and a second sub-band associated with a second modulation order and a second rank and transmit a single transport block via the set of sub-bands in the integrated spectrum channel, where the single transport block is generated based on a set of code blocks associated with the single transport block being mapped to the set of sub-bands in accordance with a mapping configuration, where the mapping configuration is based on the first modulation order being different from the second modulation order, the first rank being different from the second rank, or both.

In some examples of the method, wireless devices, and non-transitory computer-readable medium described herein, the mapping configuration may be based on the first modulation order being different from the second modulation order and the method, apparatuses, and non-transitory computer-readable medium may include further operations, features, means, or instructions for mapping a set of coded bits associated with a first code block of the set of code blocks to a set of ordered constellation bits across the first sub-band and the second sub-band, where the set of ordered constellation bits may be based on a sequencing of a cumulative set of constellation bits from a most significant bit to a least significant bit, and where the cumulative set of constellation bits includes one or more first constellation bits associated with the first modulation order and one or more second constellation bits associated with the second modulation order.

In some examples of the method, wireless devices, and non-transitory computer-readable medium described herein, the mapping configuration may be based on the first modulation order being different from the second modulation order and the method, apparatuses, and non-transitory computer-readable medium may include further operations, features, means, or instructions for interleaving a set of coded bits associated with a first code block, of the set of code blocks, across the set of sub-bands based on ordering the first sub-band before the second sub-band in accordance with the first modulation order being greater than the second modulation order.

In some examples of the method, wireless devices, and non-transitory computer-readable medium described herein, interleaving the set of coded bits may include operations, features, means, or instructions for mapping the set of coded bits into a matrix of entries, where one or more rows of the matrix each include a set of unavailable entries restricted from being mapped to, where the set of unavailable entries may be associated with the second sub-band based on the second modulation order being smaller than the first modulation order.

In some examples of the method, wireless devices, and non-transitory computer-readable medium described herein, interleaving the set of coded bits may include mapping the set of coded bits into a matrix of entries, and the method, apparatuses, and non-transitory computer-readable medium may include further operations, features, means, or instructions for puncturing a set of entries in each row of one or more rows of the matrix based on the first modulation order being greater than the second modulation order, where the set of entries may be associated with the second sub-band based on the second modulation order being smaller than the first modulation order.

In some examples of the method, wireless devices, and non-transitory computer-readable medium described herein, the one or more rows include at least a first row of the matrix and each row of the one or more rows include a set of non-punctured entries associated with the first sub-band and the set of punctured entries associated with the second sub-band based on the first modulation order being greater than the second modulation order.

In some examples of the method, wireless devices, and non-transitory computer-readable medium described herein, the mapping configuration may be based on the first rank being different from the second rank and the method, apparatuses, and non-transitory computer-readable medium may include further operations, features, means, or instructions for interleaving, for each code block of the set of code blocks, a first subset of a set of coded bits associated with a respective code block across the first sub-band in accordance with the first rank being smaller than the second rank and interleaving, for each code block of the set of code blocks, a second subset of the set of coded bits across the second sub-band based on the first subset of the set of coded bits being interleaved across the first sub-band.

Some examples of the method, wireless devices, and non-transitory computer-readable medium described herein may further include operations, features, means, or instructions for interleaving the set of coded bits in accordance with the first rank being smaller than the second rank may be based on rank being associated with a higher priority than modulation order.

In some examples of the method, wireless devices, and non-transitory computer-readable medium described herein, the mapping configuration may be a first mapping configuration and the method, apparatuses, and non-transitory computer-readable medium may include further operations, features, means, or instructions for communicating control signaling indicative of a set of multiple mapping configurations including at least the first mapping configuration.

Some examples of the method, wireless devices, and non-transitory computer-readable medium described herein may further include operations, features, means, or instructions for communicating second control signaling indicative of the first mapping configuration from the set of multiple mapping configurations, where the set of code blocks associated with the single transport block being mapped to the set of sub-bands in accordance with the first mapping configuration may be based on communication of the second control signaling.

Some examples of the method, wireless devices, and non-transitory computer-readable medium described herein may further include operations, features, means, or instructions for selecting the first mapping configuration from the set of multiple mapping configurations, where the set of code blocks associated with the single transport block being mapped to the set of sub-bands in accordance with the first mapping configuration may be based on selection of the first mapping configuration.

### BRIEF DESCRIPTION OF THE DRAWINGS

FIG. 1 shows an example of a wireless communication system.

FIG. 2 shows an example of a signaling diagram that supports bit to constellation mapping for flexible spectrum integration (FSI).

FIG. 3 shows an example of a mapping configuration that supports bit to constellation mapping for FSI.

FIG. 4 shows an example of a mapping configuration that supports bit to constellation mapping for FSI.

FIG. 5 shows an example of a mapping configuration that supports bit to constellation mapping for FSI.

FIG. 6 shows an example of a process flow that supports bit to constellation mapping for FSI.

FIG. 7 shows a block diagram of a processing system that supports bit to constellation mapping for FSI.

FIG. 8 shows a diagram of a system including a UE that supports bit to constellation mapping for FSI in accordance with one or more aspects of the present disclosure.

FIG. 9 shows a diagram of a system including a network entity that supports bit to constellation mapping for FSI in accordance with one or more aspects of the present disclosure.

FIG. 10 shows a flowchart illustrating methods that support bit to constellation mapping for FSI.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communications systems may support flexible spectrum integration (FSI) in which a wireless device may communicate via resources across multiple frequency bands to form a virtual cell. That is, an integrated spectrum channel may be formed by combining frequency resources from the multiple frequency bands into a set of sub-bands, where each sub-band generally includes a subset of frequency resources within a physical carrier, a single physical carrier, or multiple physical carriers within a corresponding frequency band. Thus, the wireless device may transmit a single transport block (TB) via the set of sub-bands of the integrated spectrum channel, where the single TB is generated by mapping, via an interleaver, each code block (CB) of a set of CBs (e.g., to be transmitted) to a different sub-band of the set of sub-bands. However, in some cases, each sub-band (e.g., at least one sub-band) of the set of sub-bands may be associated with a different modulation order, a different rank, or both. In such cases, the wireless device may be unable to determine how to map the set of CBs to the set of sub-bands.

Aspects of the subject matter described in this disclosure relate to techniques for mapping each CB, of a set of CBs associated with a single TB, to a set of sub-bands associated with an integrated spectrum channel when each sub-band (e.g., at least one sub-band) of the set of sub-bands is associated with a different modulation order, a different rank, or both. For example, a first modulation order associated with a first sub-band of the set of sub-bands may be different from a second modulation order associated with a second sub-band of the set of sub-bands. In some cases, the wireless device may interleave a set of coded bits associated with each CB at a bit level, where the interleaving considered reliability of different modulation orders, reliabilities of layers across sub-bands, or both. That is, for example, the wireless device may cumulatively order a first set of constellation bits associated with the first modulation order and a second set of constellation bit associated with the second modulation order from most reliable to least reliable, and may, for each CB, map a set of coded bits to the ordered set of constellation bits from the most reliable to the least reliable.

Additionally, or alternatively, the wireless device may, for each CB of the set of CBs, map a set of coded bits to the set of sub-bands in accordance with a single systematic bit prioritized mapping (SBPM) interleaver modified with one or more unavailable entries or one or more punctured entries. That is, to perform SBPM interleaving, the wireless device may generate a matrix of entries, where each portion of the matrix is associated with a respective modulation order (e.g., and corresponding sub-band) and where the portions of the matrix are ordered based on modulation order, from highest modulation order to lowest modulation order. Thus, each portion of the matrix associated with a modulation order lower than the highest modulation order may include one or more unavailable entries or one or more punctured entries based on the respective portion being associated with a modulation order lower than the highest modulation order.

Additionally, or alternatively, the wireless device may, for each CB of the set of CBs, map a set of coded bits to the set of sub-bands and may interleave the set of coded bits in accordance with multiple SBPM interleavers, where an ordering of the sub-bands and, thus, the interleaving, depends on a rank of each sub-band. That is, for each CB, the wireless device may map a first subset of the set of coded bits to a first matrix of entries associated with the first sub-band and may map a second subset of the set of coded bits to a second matrix of entries associated with the second sub-band, where the first matrix of entries is ordered before the second matrix of entries based on a first rank associated with the first sub-band being lower than a second rank associated with the second sub-band (e.g., regardless of modulation order). Thus, the wireless device may interleave, via a first SBPM interleaver, the first matrix of entries prior to interleaving, via a second SBPM interleaver, the second matrix of entries based on the first rank being lower than the second rank.

Particular aspects of the subject matter described in this disclosure can be implemented to realize one or more of the following potential advantages. In some examples, by mapping each CB of a set of CBs to a set of sub-bands associated with an integrated spectrum channel when each sub-band (e.g., at least one sub-band) of the set of sub-bands is associated with a different modulation order, a different rank, or both, each CB may experience different channel conditions, thus increasing communication robustness and decreasing a likelihood of failed transmissions. Additionally, by cumulatively ordering constellation bits associated with multiple modulation orders from most reliable to least reliable, or by ordering modulation orders from highest modulation order to lowest modulation order, systematic bits may be mapped to more reliable constellation bits and parity bits may be mapped to less reliable constellation bits, further increasing communication robustness and decreasing the likelihood of failed transmissions.

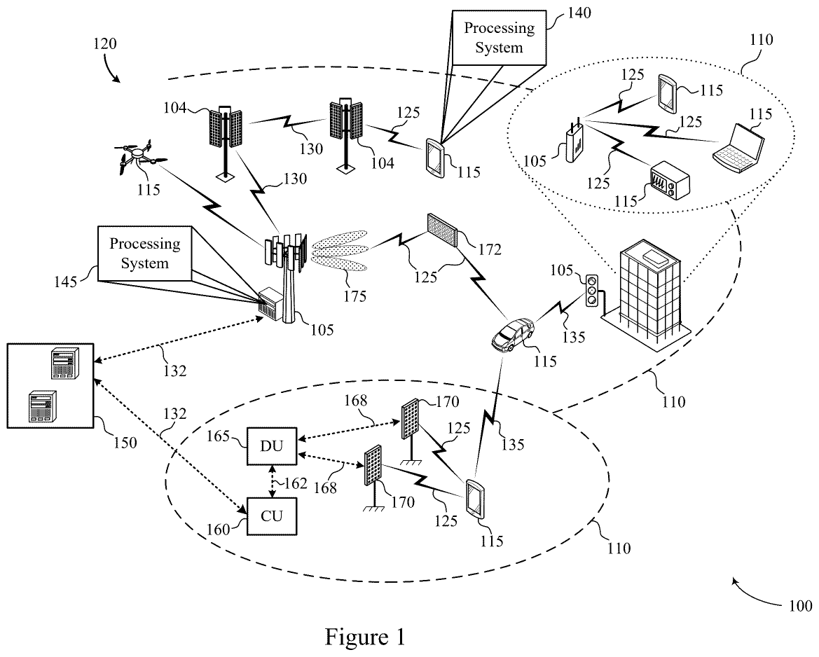

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for bit to constellation mapping for FSI. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support techniques for mapping each CB, of a set of CBs associated with a single TB, to a set of sub-bands associated with an integrated spectrum channel when each sub-band (e.g., at least one sub-band) of the set of sub-bands is associated with a different modulation order, a different rank, or both, which may rules in increased communication robustness and a decreased likelihood of failed transmissions.

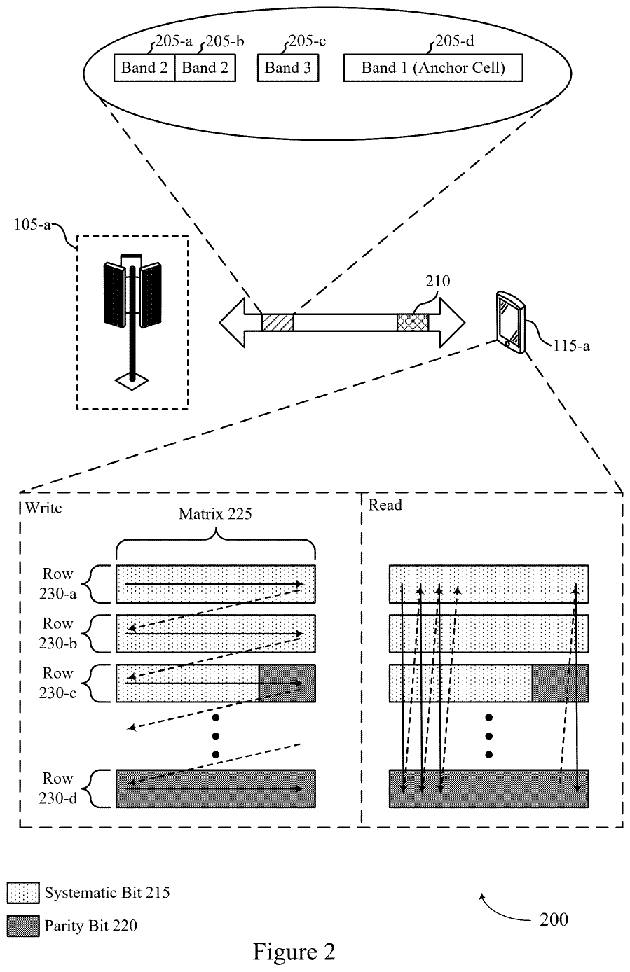

FIG. 2 shows an example of a signaling diagram 200 that supports bit to constellation mapping for FSI. In some cases, the signaling diagram 200 may implement or be implemented by aspects of the wireless communication system 100. For example, the signaling diagram 200 may include one or more UEs 115 (e.g., a UE 115-a) and one or more network entities 105 (e.g., a network entity 105-a), which may be examples of the corresponding devices as described herein.

In some cases, a wireless communications system may support FSI. Broadly, FSI may include mixing and matching frequency resources from different frequency bands to form a virtual cell (e.g., to support single-cell operations). In the non-limiting example shown in FIG. 2, this may include the virtual cell including an integrated spectrum channel formed using a set of sub-bands 205, where the set of sub-bands 205 are formed by combining frequency resources from multiple frequency bands. For example, a sub-band 205-a and a sub-band 205-b may be formed using frequency resources from frequency band 2 (e.g., Band 2), a sub-band 205-c may be formed using frequency resources from frequency band 3 (e.g., Band 3), and a sub-band 205-d may be formed using frequency resources from frequency band 1 (e.g., Band 1). Accordingly, each sub-band 205 in the set of sub-bands 205 include a subset of frequency resources within a physical carrier, a single physical carrier, or multiple physical carriers within the corresponding frequency band. Frequency band 1 may generally be associated with or otherwise designated as an anchor cell (e.g., associated with scheduling wireless communications for the virtual cell).

In some aspects, a transmitting device may receive or otherwise obtain configuration information for the integrated spectrum channel. For example, when the transmitting device is the UE 115-a, this may include the network entity 105-a transmitting or otherwise outputting (and the UE 115-a receiving or otherwise obtaining) a control message 210 indicating the configuration information for the integrated spectrum channel. The network entity 105-a, in this example, may obtain the configuration information for the integrated spectrum channel by forming, selecting, or otherwise allocating the configuration information and then providing the configuration information to the UE 115-a via the control message 210. Thus the UE 115-a may receive an indication of the configuration information from the network entity 105-a via the control message 210, via other (pre)configured information associated with the network entity 105-a, or both.

Accordingly, a single TB (e.g., for downlink communications when the network entity 105-a is the transmitting device or for uplink communications when the UE 115-a is the transmitting device) may be scheduled over the set of non-contiguous frequency resources (e.g., over the integrated spectrum channel). A non-contiguous BWP may be configured that spans over the set of aggregated frequency resources across different physical channels. Additionally, or alternatively, separate BWPs may be configured on different sub-bands where the signal TB is scheduled across the different sub-bands. In the uplink example, for CP-OFDM, the single TB may be mapped to multiple non-contiguous portions (e.g., chunks) of the frequency spectrum. In the uplink example, for DFT-s-OFDM, there may be one or more peak-average-power-ratio (PAPR) considerations with regards to non-contiguous frequency resource mapping. If the UE 115-a has multiple power amplifiers with each being connected to one contiguous segment (e.g., of the frequency spectrum), the single TB may be mapped to a non-contiguous set of frequency resources without PAPR impacts.

Communicating a single TB over the integrated spectrum channel may support additional diversity in lower frequency bands (e.g., small FDD bands). This may support a single component carrier (CC) control channel element (CCE)/blind decoding operations of the UE 115-a. Different from carrier aggregation (CA) techniques, the integrated spectrum channel does not result in the scaling up a physical downlink control channel (PDCCH) load with the quantity of CCs (e.g., due to the anchor cell), thereby significantly reducing UE power consumption. This may provide additional bandwidth adaptations using BWP mechanisms, which is less complex and resource-intensive than secondary cell addition, release, activation, and deactivation mechanisms associated with CA techniques.

In some cases, the gain of single TB FSI may be based on the fact that, with proper interleaving, each CB may be mapped to different sub-bands and, thus, experience different channel conditions. However, if one or more link parameters, such as modulation order (e.g., QAM order), rank, or the like thereof, are different across (e.g., between) different sub-bands, the UE 115-a (e.g., the transmitting device) may not be capable of performing SBPM interleaving.

SBPM may include systematic bits 215 (e.g., systematic portion of a set of coded bits) being mapped to the most significant bits (MSB) of a modulated constellation (symbols) and parity bits 220 (e.g., non-systematic bits) being mapped to the least significant bit (LSBs) of the modulated constellation. This may be performed where the bits (e.g., coded bits) are written (e.g., mapped) into a matrix 225 in a row-first manner and then read in a column-first manner. For example, the bits (e.g., of a CB) may be written into a row 230-a first, then into a row 230-b, then into a row 230-c, then into a row 230-d, where the row 230-a is associated with the MSB of the modulated symbols and finally the row 230-d may be associated with the LSB of the modulated symbols. In such cases, the matrix 225 may be generated based on the modulation order in a column domain and based on a rate matching output divided by the modulation order in the row domain. SBPM may result in copies of the same variable nodes (VN) in a base graph (BS) experiencing similar channel reliabilities (e.g., reliabilities within a threshold deviation) and different VNs in the BG may experience different channel reliabilities. Thus, SBPM may improve a decoding threshold of quasi-cyclic low-density parity-check (QC-LDPC). In some cases, for FIS, the UE 115-a may support multiple SBPM interleavers or a single SBPM interleaver with a natural ordering of sub-bands aligning bit levels on the MSB.

However, as described herein, when at least one sub-band in the set of sub-bands associated with a flexible integrated channel is associated with a different modulation order, different rank, or both (e.g., compared to other sub-bands in the set of sub-bands), the UE 115-a (e.g., transmitting device) may not be able to determine how to perform SBPM. That is, interleaving bits in a frequency domain in accordance with an SBPM scheme may not be capable when modulation orders, rank, or both, are different across different sub-bands.

Accordingly, techniques described herein may support interleaving at a bit level (e.g., bit to constellation mapping) that considers reliabilities of different modulation orders, reliabilities of layers across sub-bands, or both. In some cases, the UE 115-a may perform SBPM by ordering a reliability of each bit level across modulation orders (e.g., and rank for multiple layers) and may map coded bits of a CB to the bit levels of different QAM sizes (e.g., on different sub-bands) based on the determined reliability order across the multiple QAM orders.

That is, when a first sub-band (e.g., of the set of sub-bands associated with the integrated spectrum channel) is associated with a first modulation order and a second sub-band (e.g., of the set of sub-bands) is associated with a second modulation order, different from the first modulation order, the UE 115-a may map a set of CBs associated with a single TB to the set-of sub-bands in accordance with a first mapping configuration. The first mapping configuration may indicate for the UE 115-a to map a set of coded bits associated with each CB (e.g., of the set of CBs) to a set of ordered constellation bits (e.g., QAM bits) across the first sub-band and the second sub-band. In such cases, the set of ordered constellation bits may be based on cumulatively ordering a first set of constellation bits associated with the first modulation order and a second set of constellation bit associated with the second modulation order from most reliable (e.g., MSB) to least reliable (e.g., LSB).

For example, the first sub-band may be associated with 16-QAM and the second sub-band may be associated with 4-QAM. Thus, a codeword with 4M+2N coded bits may be mapped to M 16-QAM symbols (e.g., a set of 16-QAM constellation bits) and N 4-QAM symbols (e.g., a set of 4-QAM constellation bits). For 16-QAM and 4-QAM, an estimate of a reliability of constellation bits (e.g., without knowing a channel) may be as follows (e.g., from most reliable to least reliable): MSB (16-QAM)>2^{nd} MSB (16-QAM)>MSB (4-QAM)>3^{rd} MSB (16-QAM)>LSB (4-QAM) >LSB (16-QAM). That is, the MSB of 16-QAM may be the most reliable constellation bit and the LSB of 16-QAM may be the least reliable constellation bit. Thus, b₀b₁b₂ . . . b_{M-1} coded bits of the 4M+2N coded bits may be mapped to the MSB (16-QAM), b_{M} . . . b_{2M} coded bits of the 4M+2N coded bits may be mapped to the 2^{nd} MSB (16-QAM), b_{2M+1} . . . b_{2M+N} coded bits of the 4M+2N coded bits may be mapped to the MSB (4-QAM), b_{2M+N+1} . . . b_{3M+N} coded bits of the 4M+2N coded bits may be mapped to the 3^{rd} MSB (16-QAM), b_{3M+N+1} . . . b_{3M+2N} coded bits of the 4M+2N coded bits may be mapped to the LSB (4-QAM), and b_{3M+2N+1} . . . b_{4M+2N} coded bits of the 4M+2N coded bits may be mapped to the LSB (16-QAM).

In some cases, ordering of a bit mapping (e.g., constellation bit mapping) may be preconfigured at the UE 115-a. For example, each combination of modulation orders (e.g., from a set of modulation orders supported by the UE 115-a), which may be referred to as a modulation order combination, may be associated with an ordering of a bit mapping and a table may include associations between each modulation order combination and a respective ordering of a bit mapping, where the table is preconfigured at the UE 115-a. For example, the combination of 16-QAM and 4-QAM may be associated with the aforementioned ordering of a bit mapping of MSB(16-QAM)>2^{nd} MSB(16-QAM)>MSB(4-QAM >3^{rd} MSB(16-QAM)>LSB(4-QAM)>LSB(16-QAM). Additionally, or alternatively, the network entity 105-a may transmit, to the UE 115-a, an indication of the table.

Though described in the context of the UE 115-a being the transmitting device and the network entity 105-a being the receiving device, this is not to be regarded as a limitation of the present disclosure. In this regard, the transmitting device may be any time of wireless device and the receiving device may similarly be any type of wireless device. For example, the transmitting device may be the network entity 105-a and the receiving device may be the UE 115-a. In another example, the transmitting device may be the UE 115-a and the receiving device may be another UE 115.

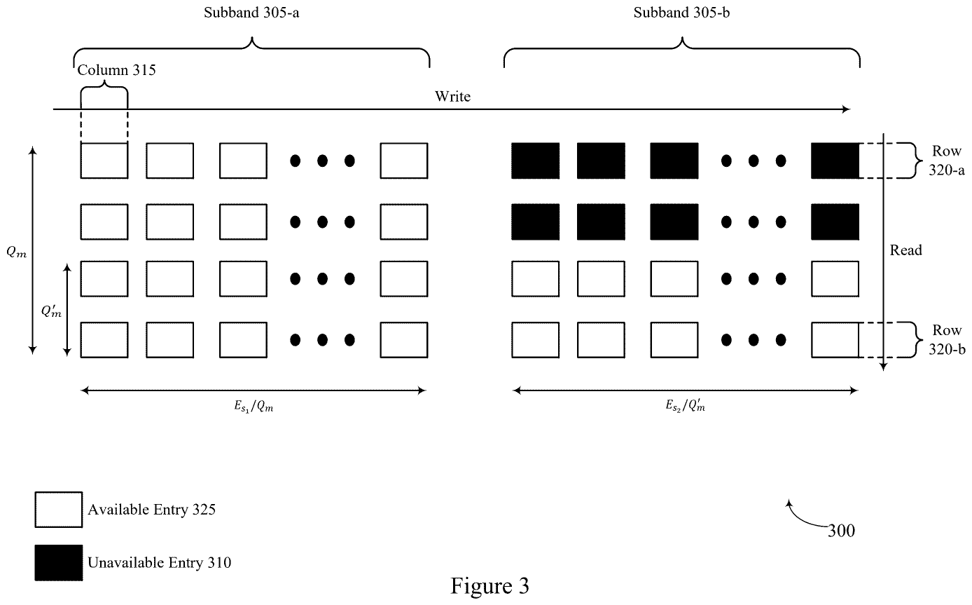

FIG. 3 shows an example of a mapping configuration 300 that supports bit to constellation mapping for FSI. In some cases, the mapping configuration 300 may implement or be implemented by aspects of the wireless communication system 100, the signaling diagram 200, or both. For example, the mapping configuration 300 may be implemented by one or more UEs 115 and one or more network entities 105, which may be examples of the corresponding devices as described herein.

As described herein, in some cases, an integrated spectrum channel may be associated with a set of sub-bands 305, where at least one sub-band 305 of the set of sub-bands 305 is associated with a different modulation order, a different rank, or both. For example, a sub-band 305-a (e.g., of the set of sub-bands 305) may be associated with a first modulation order, Qₘ (e.g., 16-QAM), and a sub-band 305-b (e.g., of the set of sub-bands 305) may be associated with a second modulation order, Qₘ ′ (e.g., 4-QAM), different from the first modulation order. In such cases, a UE 115 may map a set of CBs associated with a single TB to the set-of sub-bands 305 in accordance with the mapping configuration 300 (e.g., a second mapping configuration), where each CB from the set of CBs is mapped to the set of sub-bands 305 (e.g., more than one sub-band). The mapping configuration 300 may be associated with a single SBPM interleaver modified with one or more unavailable entries 310. That is, the mapping configuration 300 may illustrate a non-limiting example where SBPM is performed per CB with one or more unavailable entries 310 (e.g., which is different than block interleaving read/write operations due to unavailable bit levels).

For example, to perform bit to modulation (e.g., QAM) mapping to different sub-bands 305, a transmitting device (e.g., a single block interleaver at the transmitting device) may generate a matrix of entries (e.g., including one or more available entries 325 and one or more unavailable entries 310), where the matrix is defined by a set of columns 315 and a set of row 320. In such cases, the transmitting device may generate the matrix of entries by ordering sizes of the different modulation orders (e.g., QAM sizes) from largest (e.g., highest size) to smaller (e.g., lowest size). That is, each sub-band 305 (e.g., modulation order) may correspond to a respective portion of the matrix (e.g., a respective set of one or more columns 315), where the respective portions of the matrix are ordered from largest modulation order to smallest modulation order. In such cases, a quantity of columns 315 in each portion of the matrix may be based on (e.g., equal to) a quantity of coded bits (e.g., Eₛ_{ᵢ}) to be transmitted via a respective sub-band 305 (e.g., i) divided by the modulation order. Additionally, a quantity of rows 320 of the matrix may be equal to the largest modulation order across the set of sub-bands 305.

For example, the first modulation order, Qₘ, associated with the sub-band 305-a may be greater than the second modulation order, Q′ₘ, associated with the sub-band 305-b, such that a first portion of the matrix may be associated with the sub-band 305-a and a second portion of the matrix may be associated with the sub-band 305-b based on the first modulation order being greater (e.g., in size) than the second modulation order. The first portion of the matrix associated with the sub-band 305-a may include a first set of columns 315 based on Eₛ_{₁} coded bits (e.g., of a CB) to be transmitted via the sub-band 305-a divided by the first modulation order, Qₘ, and the second portion of the matric associated with the sub-band 305-b may include a second set of columns 315 based on Eₛ_{₂} coded bits (e.g., of the CB) to be transmitted via the sub-band 305-b divided by the second modulation order, Q′ₘ, where a total quantity of coded bits, Eᵣ, to be transmitted in the set of sub-bands (e.g., for the CB) may be equal to Eₛ_{₁}+Eₛ_{₂}. In other words, the set of sub-bands 305 may be ordered (e.g., re-ordered in terms of CB to RE mapping) based on a respective modulation order of each of the sub-bands 305, such that a sub-band 305 associated with a higher modulation order may be ordered at a beginning of the CB (e.g., at a beginning of the matrix).

Additionally, due to the quantity of rows 320 of the matrix being equal to the largest modulation order across the set of sub-bands 305, the matrix may include one or more unavailable entries 310, where the one or more unavailable entries 310 are in a first quantity of rows 320 associated with lower modulation order (e.g., the sub-band 305-b), such that modulation bit levels of each modulation order may be aligned from a LSB of each modulation order. For example, as depicted in FIG. 2, a first two rows 320 of the second portion of the matrix associated with the lower modulation order may each include a set of unavailable entries 310, such that a row 320-b includes a set of available entries 325 that correspond to a LSB of the first modulation order and a LSB of the second modulation order. Conversely, a row 320-a may include a set of available entries 325 that correspond to a MSB of the first modulation order and a set of unavailable entries 310 associated with the second modulation order. Thus, the transmitting wireless device may write a set of coded bits (e.g., associated with a CB from the set of CBs) to the matrix in the following order: MSB of the first modulation order, 2^{nd} MSB of the first modulation order, 3^{rd} MSB of the first modulation order, MSB of the second modulation order, LSB of the first modulation order, and LSB of the second modulation order. Since a network entity 105 may select different modulation orders for different sub-bands 305, the sub-bands 305 associated with greater modulation orders (e.g., higher QAM) may be associated with better channel conditions than lower modulation orders, such that the ordering may roughly follow a reliability of bit levels associated with different modulation orders.

Though described in the context of two sub-bands 305, this is not to be regarded as a limitation of the present disclosure. In this regard, any quantity of sub-bands 305 (e.g., each CB gets mapped to more than two sub-bands 305) may be considered with regards to the techniques described herein, where the quantity of sub-bands are ordered from largest modulation order to smallest modulation order, and where each modulation order smaller than the largest modulation order includes one or more unavailable entries 310 in a respective quantity of rows 320.

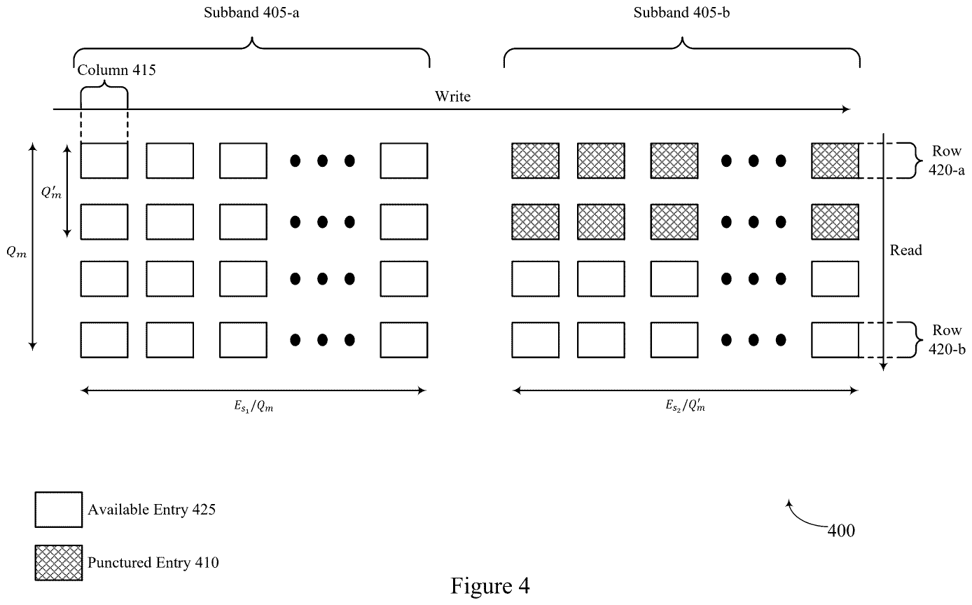

FIG. 4 shows an example of a mapping configuration 400 that supports bit to constellation mapping for FSI. In some cases, the mapping configuration 400 may implement or be implemented by aspects of the wireless communication system 100, the signaling diagram 200, the mapping configuration 300, or any combination thereof. For example, the mapping configuration 400 may be implemented by one or more UEs 115 and one or more network entities 105, which may be examples of the corresponding devices as described herein.

In some cases, instead of a matrix including one or more unavailable entries (e.g., which corresponds to rate matching), as described with reference to FIG. 3, a matrix may include one or more punctured entries 410 (e.g., which corresponds to sending different parities). Puncturing entries rather than making entries unavailable (e.g., sending different parities rather than performing rate matching) may be implemented by an interleaver by padding 0 log-likelihood ratios (LLRs) for locations of the one or more punctured entries 410 (e.g., punctured entries are 0s), such that read and write operations may be simpler than with one or more unavailable entries (e.g., simpler than rate matching).

For example, as described with reference to FIG. 3, an integrated spectrum channel may be associated with a set of sub-bands 405, where at least one sub-band 405 of the set of sub-bands 405 is associated with a different modulation order, a different rank, or both. For example, a sub-band 405-a (e.g., of the set of sub-bands 405) may be associated with a first modulation order, Qₘ (e.g., 16-QAM), and a sub-band 405-b (e.g., of the set of sub-bands 405) may be associated with a second modulation order, Q′ₘ (e.g., 4-QAM), different from the first modulation order. In such cases, a UE 115 may map a set of CBs associated with a single TB to the set-of sub-bands 405 in accordance with the mapping configuration 400 (e.g., a third mapping configuration), where each CB from the set of CBs is mapped to the set of sub-bands 405 (e.g., more than one sub-band). The mapping configuration 400 may be associated with a single SBPM interleaver modified with one or more punctured entries 410. That is, the mapping configuration 400 may illustrate a non-limiting example where SBPM is performed per CB with one or more punctured entries 410.

For example, to perform bit to modulation (e.g., QAM) mapping to different sub-bands 405, a transmitting device (e.g., a single block interleaver at the transmitting device) may generate a matrix of entries (e.g., including one or more available entries 425 and one or more punctured entries 410), where the matrix is defined by a set of columns 415 and a set of row 420. In such cases, the transmitting device may generate the matrix of entries by ordering sizes of the different modulation orders (e.g., QAM sizes) from largest (e.g., highest size) to smaller (e.g., lowest size). That is, each sub-band 405 (e.g., modulation order) may correspond to a respective portion of the matrix (e.g., a respective set of one or more columns 415), where the respective portions of the matrix are ordered from largest modulation order to smallest modulation order. In such cases, a quantity of columns 415 in each portion of the matrix may be based on (e.g., equal to) a quantity of coded bits (e.g., Eₛ_{ᵢ}) to be transmitted via a respective sub-band 405 (e.g., i) divided by the modulation order. Additionally, a quantity of rows 420 of the matrix may be equal to the largest modulation order across the set of sub-bands 405.

For example, the first modulation order, Qₘ, associated with the sub-band 405-a may be greater than the second modulation order, Q′ₘ, associated with the sub-band 405-b, such that a first portion of the matrix may be associated with the sub-band 405-a and a second portion of the matrix may be associated with the sub-band 405-b based on the first modulation order being greater (e.g., in size) than the second modulation order. The first portion of the matrix associated with the sub-band 405-a may include a first set of columns 415 based on Eₛ_{₁} coded bits (e.g., of a CB) to be transmitted via the sub-band 405-a divided by the first modulation order, Qₘ, and the second portion of the matric associated with the sub-band 405-b may include a second set of columns 415 based on Eₛ_{₂} coded bits (e.g., of the CB) to be transmitted via the sub-band 405-b divided by the second modulation order, Q′ₘ, where a total quantity of coded bits, Eᵣ, to be transmitted in the set of sub-bands (e.g., for the CB) may be equal to Eₛ_{₁}+Eₛ_{₂}. In other words, the set of sub-bands 405 may be ordered (e.g., re-ordered in terms of CB to RE mapping) based on a respective modulation order of each of the sub-bands 405, such that a sub-band 405 associated with a higher modulation order may be ordered at a beginning of the CB (e.g., at a beginning of the matrix).

Additionally, due to the quantity of rows 420 of the matrix being equal to the largest modulation order across the set of sub-bands 405, the matrix may include one or more punctured entries 410, where the one or more punctured entries 410 are in a first quantity of rows 420 associated with lower modulation order (e.g., the sub-band 405-b), such that modulation bit levels of each modulation order may be aligned from a LSB of each modulation order. For example, as depicted in FIG. 2, a first two rows 420 of the second portion of the matrix associated with the lower modulation order may each include a set of punctured entries 410, such that a row 420-b includes a set of available entries 425 that correspond to a LSB of the first modulation order and a LSB of the second modulation order. Conversely, a row 420-a may include a set of available entries 425 that correspond to a MSB of the first modulation order and a set of punctured entries 410 associated with the second modulation order.

Though described in the context of two sub-bands 405, this is not to be regarded as a limitation of the present disclosure. In this regard, any quantity of sub-bands 405 (e.g., each CB gets mapped to more than two sub-bands 405) may be considered with regards to the techniques described herein, where the quantity of sub-bands are ordered from largest modulation order to smallest modulation order, and where each modulation order smaller than the largest modulation order includes one or more punctures entries 410 in a respective quantity of rows 420.

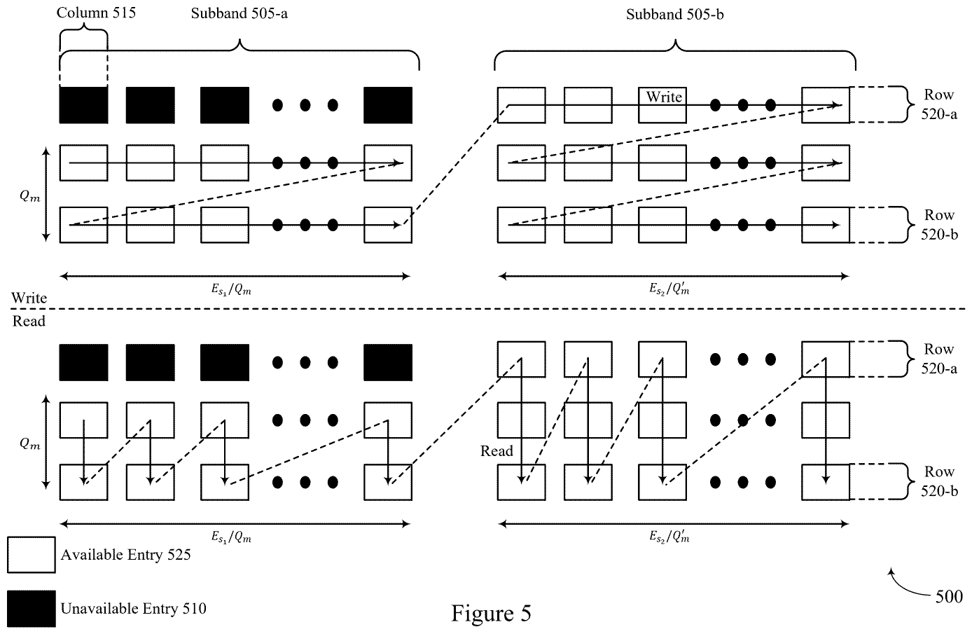

FIG. 5 shows an example of a mapping configuration 500 that supports bit to constellation mapping for FSI. In some cases, the mapping configuration 500 may implement or be implemented by aspects of the wireless communication system 100, the signaling diagram 200, the mapping configuration 300, the mapping configuration 400, or any combination thereof. For example, the mapping configuration 500 may be implemented by one or more UEs 115 and one or more network entities 105, which may be examples of the corresponding devices as described herein.

As described herein, an integrated spectrum channel may be associated with a set of sub-bands 505, where at least one sub-band 505 of the set of sub-bands 405 is associated with a different modulation order, a different rank, or both. For example, a sub-band 505-a (e.g., of the set of sub-bands 405) may be associated with a first modulation order, Qₘ (e.g., 16-QAM) and a first rank, and a sub-band 505-b (e.g., of the set of sub-bands 405) may be associated with a second modulation order, Qₘ ′ (e.g., 4-QAM) and a second rank, where the first modulation order is different than the second modulation order and where the first rank is different than the second rank. In such cases, a UE 115 may map a set of CBs associated with a single TB to the set-of sub-bands 505 in accordance with the mapping configuration 500 (e.g., a fourth mapping configuration), where each CB from the set of CBs is mapped to the set of sub-bands 505 (e.g., more than one sub-band).

The mapping configuration 500 may be associated with multiple sub-bands 505 having different ranks, such that an ordering of the sub-bands (e.g., in terms of CB to RE mapping) and interleaving may depend on the rank of each sub-band 505, the modulation order of each sub-band 505, or both. In such cases, ordering of the sub-bands 505 based on rank may be prioritized over ordering of the sub-bands 505 based on modulation order, as described with reference to FIGS. 3 and 4. That is, a sub-band 505 associated with a lower rank may be ordered before a sub-band 505 associated with a higher rank, regardless of modulation order.

For example, to perform bit to modulation (e.g., QAM) mapping to different sub-bands 505, a transmitting device (e.g., a single block interleaver at the transmitting device) may generate multiple matrices of entries (e.g., each including one or more available entries 525 and, optionally, one or more unavailable entries 510), where each matrix is defined by a set of columns 515 and a set of row 520. In such cases, the transmitting device may generate the matrices by ordering rank of the different modulation orders (e.g., QAM sizes) from lowest (e.g., smallest) to highest (e.g., largest), regardless of modulation order. That is, each sub-band 505 may correspond to a respective matrix, where the respective matrices are ordered from lowest rank to highest rank, regardless of modulation order. In such cases, a quantity of columns 515 in each matrix may be based on (e.g., equal to) a quantity of coded bits (e.g., Eₛ_{ᵢ}) to be transmitted via a respective sub-band 505 (e.g., i) divided by the modulation order. Additionally, a quantity of rows 520 of each matrix may be equal to the largest modulation order across the set of sub-bands 505.

For example, the first modulation order, Qₘ, (e.g., 16-QAM) associated with the sub-band 505- a may be less than the second modulation order, Q′ₘ, (e.g., 64-QAM) associated with the sub-band 505-b, however, the first rank (e.g., rank 2) may be less than the second rank (e.g., rank 3), such that a first matrix may be associated with the sub-band 505-a and a second matrix may be associated with the sub-band 505-b based on the first rank being lower than the second rank. In other words, according to the mapping configuration 300 and the mapping configuration 400, the sub-band 505-b should be ordered before the sub-band 505-a based on the second modulation order being greater than the first modulation order. However, according to the mapping configuration 500, the sub-band 505-a is ordered before the sub-band 505-b based on the first rank being less than the second rank, even though the second modulation order is greater than the first modulation order (e.g., due to ordering based on rank having a higher priority than ordering based on modulation order).

Thus, the first matrix associated with the sub-band 505-a may include a first set of columns 515 based on Eₛ_{₁} coded bits (e.g., of a CB) to be transmitted via the sub-band 505-a divided by the first modulation order, Qₘ, and the second matrix associated with the sub-band 505-b may include a second set of columns 515 based on Eₛ_{₂} coded bits (e.g., of the CB) to be transmitted via the sub-band 505-b divided by the second modulation order, Q′ₘ, where a total quantity of coded bits, Eᵣ, to be transmitted in the set of sub-bands (e.g., for the CB) may be equal to Esₛ_{₁}+Eₛ_{₂}.

Additionally, due to the quantity of rows 520 in each matrix being equal to the largest modulation order across the set of sub-bands 505, each matrix associated with a modulation order less than the largest modulation order may include one or more unavailable entries 510, where the one or more unavailable entries 510 are in a first quantity of rows 520 associated with lower modulation order (e.g., the sub-band 505-a), such that modulation bit levels of each modulation order may be aligned from a LSB of each modulation order. For example, as depicted in FIG. 5, a first two rows 520 of the first matrix associated with the lower modulation order may each include a set of unavailable entries 510, such that a row 520-b of the first matrix includes a set of available entries 525 that correspond to a LSB of the first modulation order a row 520-a of the first matrix may include a set of unavailable entries 510.

Additionally, an SBPM may be adjusted (e.g., relative to the mapping configuration 300 and the mapping configuration 400), such that a first SBPM interleaver interleaves the Esₛ_{₁} coded bits (e.g., of the CB) on the sub-band 505-a before a second SBPM interleaver interleaves the Esₛ_{₂} coded bits (e.g., of the CB) on the sub-band 505-b (e.g., two different SBPM interleavers). That is, the first SBPM interleaver may interleave the first matrix before the second SBPM interleaver interleaves the second matrix.

Though described in the context of two sub-bands 505, this is not to be regarded as a limitation of the present disclosure. In this regard, any quantity of sub-bands 505 (e.g., each CB gets mapped to more than two sub-bands 505) may be considered with regards to the techniques described herein, where the quantity of sub-bands are ordered from lowest rank to highest rank, and where each modulation order smaller than the largest modulation order includes one or more unavailable entries 510 in a respective quantity of rows 520. Additionally, or alternatively, though described in the context of unavailable entries 510, this is not to be regarded as a limitation of the present disclosure, such that the unavailable entries 510 in FIG. 5 may be replaced with punctured entries, as described with reference to FIG. 4.

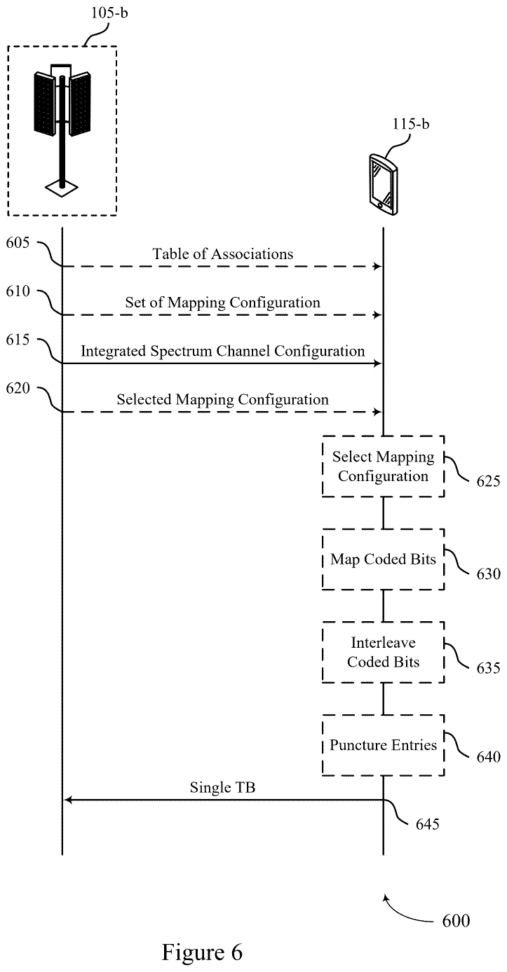

FIG. 6 shows an example of a process flow 600 that supports bit to constellation mapping for FSI. In some cases, the process flow 600 may implement or be implemented by aspects of the wireless communication system 100, the signaling diagram 200, the mapping configuration 300, the mapping configuration 400, the mapping configuration 500, or any combination thereof. For example, the process flow 600 may include one or more UEs 115 (e.g., a UE 115-b) and one or more network entities 105 (e.g., a network entity 105-b), which may be examples of the corresponding devices as described herein. In the following description of the process flow 600, the operations may be communicated in a different order than the example order shown, or the operations may be performed in different orders or at different times. Some operations may also be omitted from the process flow 600, and other operations may be added to the process flow 600.

In some cases, at 605, the UE 115-b may receive, from the network entity 105-b, first control signaling indicating a table defining (e.g., including) associations between combinations of modulation orders (e.g., modulation order combinations) and structures of a respective set of ordered constellation bits (e.g., QAM bits). For example, the table may include an association between a combination of a first modulation order and a second modulation order and a first structure of the set of ordered constellation bits.

In some cases, at 610, the UE 115-b may receive, from the network entity 105-b, second control signaling indicating (e.g., the same or different as the first control signaling) indicating a set of multiple mapping configurations, including at least the first mapping configuration.

At 615, the UE 115-b may receive, from the network entity 105-b (e.g., via the first control signaling, the second control signaling, or additional control signaling), an indication of information for an integrated spectrum channel of a single virtual cell, the integrated spectrum channel including a set of sub-bands that are formed by combining frequency resources from multiple frequency bands. In such cases, the set of sub-bands may include at least a first sub-band associated with the first modulation order and a first rank and a second sub-band associated with the second modulation order and a second rank.

In some cases, at 620, the UE 115-b may receive, from the network entity 105-b, third control signaling indicating (e.g., the same or different as the first control signaling, the second control signaling, or the additional control signaling) indicating the first mapping configuration from the set of multiple mapping configurations (e.g., as selected by the network entity 105-b). In some other cases, at 625, the UE 115-b may select the first mapping configuration from the set of multiple mapping configurations.

In some cases, the first modulation order may be different than the second modulation order (e.g., and the first rank may be the same as or different than the second rank). In such cases (e.g., as described with reference to FIG. 2), at 630, the UE 115-b may map a set of coded bits associated with a first CB, of a set of CBs associated with a single TB, to a set of ordered constellation bits across the first sub-band and the second sub-band. In such cases, the set of ordered constellation bits may be based on a sequencing of a cumulative set of constellation bits from an MSB to an LSB, and the cumulative set of constellation bits may include one or more first constellation bits associated with the first modulation order and one or more second constellation bits associated with the second modulation order. In other words, the one or more first constellation bits and the one or more second constellation bits may be cumulative ordered from the MSB to the LSB to generate the set of ordered constellation bits. As described previously, the first structure (e.g., ordering) of the set of ordered constellation bits may be based on the combination of the first modulation order and the second modulation order, which may be defined in the table.

In some other cases (e.g. in accordance with the mapping configuration 300, as described with reference to FIG. 3), at 630, the UE 115-b may map each CB of the set of CBs into a matrix of entries, where one or more rows of the matrix each include a set of unavailable entries restricted from being mapped to. In such cases, the set of unavailable entries may be associated with the second sub-band based on the second modulation order being smaller than the first modulation order. In such cases, the one or more rows may include at least a first row of the matrix, such that each row of the one or more rows includes a set of available entries associated with the first sub-band and the set of unavailable entries associated with the second sub-band based on the first modulation order being greater than the second modulation order.

In some other cases (e.g., in accordance with the mapping configuration 400, as described with reference to FIG. 4), at 630, the UE 115-b may map each CB of the set of CBs into a matrix of entries, where one or more rows of the matrix each include a set of punctured entries. In such cases, the set of punctured entries may be associated with the second sub-band based on the second modulation order being smaller than the first modulation order. In such cases, the one or more rows may include at least a first row of the matrix, such that each row of the one or more rows includes a set of available entries associated with the first sub-band and the set of punctured entries associated with the second sub-band based on the first modulation order being greater than the second modulation order.

In some other cases (e.g. in accordance with the mapping configuration 500, as described with reference to FIG. 5), at 630, the UE 115-b may map, for each CB of the set of CBs, a first subset of a set of coded bits (e.g., of the respective CB) to a first portion of a matrix of entries associated with the first sub-band and may map a second subset of the set of coded bits to a second portion of the matrix of entries. In some cases, one or more rows in the first portion of the matrix of entries may include a set of unavailable entries restricted from being mapped to based on the second modulation order being greater than the first modulation order. In some other cases, one or more rows of the second portion of the matrix may include a set of unavailable entries restricted from being mapped to based on the first modulation order being greater than the second modulation order.

In some cases (e.g., in accordance with the mapping configuration 300 and the mapping configuration 400), at 635, the UE 115-b may interleave the set of coded bits associated with the first CB, of the set of CBs, across the set of sub-bands based on ordering the first sub-band before the second sub-band in accordance with the first modulation order being greater than the second modulation order. In some examples (e.g., in accordance with the mapping configuration 300), the UE 115-b may refrain from interleaving the set of coded bits to the set of unavailable entries in each row of the one or more rows.

In some other cases (e.g., in accordance with the mapping configuration 500), the UE 115-b may interleave, for each CB of the set of CBs, the first subset of the set of coded bits associated with a respective CB across the first sub-band in accordance with the first rank being smaller than the second rank and may interleave, for each CB of the set of CBs, the second subset of the set of coded bits associated with a respective CB across the second sub-band based on the first subset of the set of coded bits being interleaved across the first sub-band. That is, interleaving the set of coded bits in accordance with the first rank being smaller than the second rank is based on interleaving based on rank being associated with a higher priority than interleaving based on modulation order (e.g., based on rank being associated with a higher priority than modulation order).

In some cases, at 640 (e.g., in accordance with the mapping configuration 400), the UE 115-b may puncture the set of punctured entries associated with the second sub-band based on the second modulation order being smaller than the first modulation order.

At 645, the UE 115-b may transmit, to the network entity 105-b, the single TB via the set of sub-bands in the integrated spectrum channel. As described herein, the single TB may be generated based on the set of CBs associated with the single transport block being mapped to the set of sub-bands in accordance with the first mapping configuration, where the first mapping configuration is based on the first modulation order being different from the second modulation order, the first rank being different from the second rank, or both.

Though described in the context of the UE 115-b. being the transmitting wireless device and the network entity 105-b being the receiving wireless device, this is not to be regarded as a limitation of the present disclosure. In this regard, the transmitting device may be any time of wireless device and the receiving device may similarly be any type of wireless device. For example, the transmitting device may be the network entity 105-b and the receiving device may be the UE 115-b. In another example, the transmitting device may be the UE 115-b and the receiving device may be another UE 115.

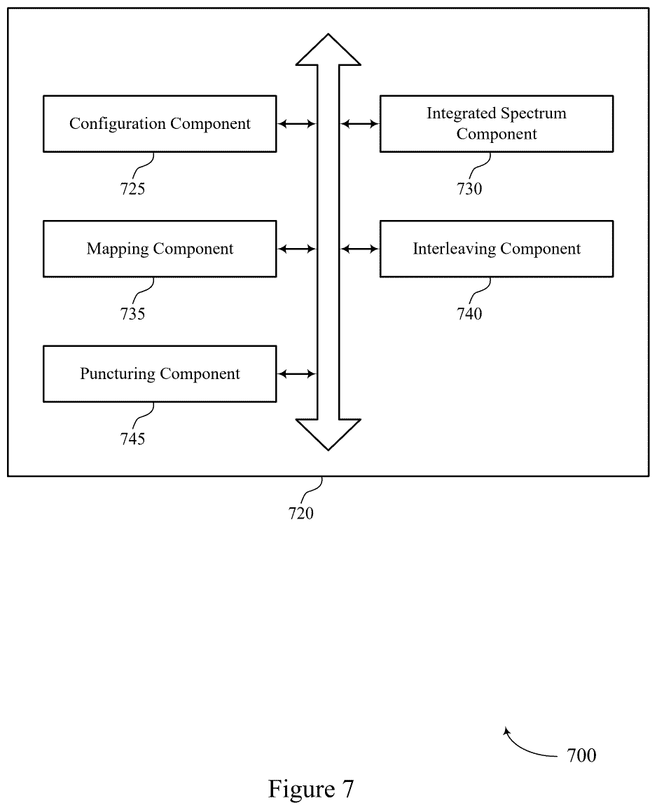

FIG. 7 shows an example of a processing system 720 that supports bit to constellation mapping for FSI. A processing system 720 may be an example of a processing system 145 (such as network entity 105) and may include a configuration component 725, an integrated spectrum component 730, a mapping component 735, an interleaving component 740, a puncturing component 745, or any combination thereof. A processing system 720, or various component thereof, may be an example of means for performing (such as a means for causing a network entity 105 to perform) various techniques described herein.

The configuration component 725 may be configured to cause the UE 115 or the network entity 105 to communicate an indication of information for an integrated spectrum channel of a single virtual cell, the integrated spectrum channel including a set of sub-bands that are formed by combining frequency resources from multiple frequency bands, where the set of sub-bands includes at least a first sub-band associated with a first modulation order and a first rank and a second sub-band associated with a second modulation order and a second rank. The integrated spectrum component 730 may be configured to cause the UE 115 or the network entity 105 to transmit a single transport block via the set of sub-bands in the integrated spectrum channel, where the single transport block is generated based on a set of code blocks associated with the single transport block being mapped to the set of sub-bands in accordance with a mapping configuration, where the mapping configuration is based on the first modulation order being different from the second modulation order, the first rank being different from the second rank, or both.

In some examples, the mapping configuration is based on the first modulation order being different from the second modulation order, and the mapping component 735 may be configured to cause the UE 115 or the network entity 105 to map a set of coded bits associated with a first code block of the set of code blocks to a set of ordered constellation bits across the first sub-band and the second sub-band, where the set of ordered constellation bits is based on a sequencing of a cumulative set of constellation bits from a most significant bit to a least significant bit, and where the cumulative set of constellation bits includes one or more first constellation bits associated with the first modulation order and one or more second constellation bits associated with the second modulation order.

In some examples, a structure of the set of ordered constellation bits is based on a combination of the first modulation order and the second modulation order.

In some examples, the configuration component 725 may be configured to cause the UE 115 or the network entity 105 to communicate control signaling indicative of a table including associations between combinations of modulation orders and structures of a respective set of ordered constellation bits, where the table includes an association between the combination of the first modulation order and the second modulation order and the structure of the set of ordered constellation bits.

In some examples, the mapping configuration is based on the first modulation order being different from the second modulation order, and the interleaving component 740 may be configured to cause the UE 115 or the network entity 105 to interleave a set of coded bits associated with a first code block, of the set of code blocks, across the set of sub-bands based on ordering the first sub-band before the second sub-band in accordance with the first modulation order being greater than the second modulation order.

In some examples, to support interleaving the set of coded bits, the mapping component 735 may be configured to cause the UE 115 or the network entity 105 to map the set of coded bits into a matrix of entries, where one or more rows of the matrix each include a set of unavailable entries restricted from being mapped to, where the set of unavailable entries are associated with the second sub-band based on the second modulation order being smaller than the first modulation order.

In some examples, the one or more rows include at least a first row of the matrix. In some examples, each row of the one or more rows include a set of available entries associated with the first sub-band and the set of unavailable entries associated with the second sub-band based on the first modulation order being greater than the second modulation order.

In some examples, to support interleaving the set of coded bits, the interleaving component 740 may be configured to cause the UE 115 or the network entity 105 to refrain from interleaving the set of coded bits to the set of unavailable entries in each row of the one or more rows.

In some examples, interleaving the set of coded bits may include mapping the set of coded bits into a matrix of entries and the puncturing component 745 may be configured to cause the UE 115 or the network entity 105 to puncture a set of entries in each row of one or more rows of the matrix based on the first modulation order being greater than the second modulation order, where the set of entries are associated with the second sub-band based on the second modulation order being smaller than the first modulation order.

In some examples, the one or more rows include at least a first row of the matrix. In some examples, each row of the one or more rows include a set of non-punctured entries associated with the first sub-band and the set of punctured entries associated with the second sub-band based on the first modulation order being greater than the second modulation order.

In some examples, the mapping configuration is based on the first rank being different from the second rank, and the interleaving component 740 may be configured to cause the UE 115 or the network entity 105 to interleave, for each code block of the set of code blocks, a first subset of a set of coded bits associated with a respective code block across the first sub-band in accordance with the first rank being smaller than the second rank. In some examples, the mapping configuration is based on the first rank being different from the second rank, and the interleaving component 740 may be configured to cause the UE 115 or the network entity 105 to interleave, for each code block of the set of code blocks, a second subset of the set of coded bits across the second sub-band based on the first subset of the set of coded bits being interleaved across the first sub-band.

In some examples, to support interleaving the first subset of the set of coded bits, the mapping component 735 may be configured to cause the UE 115 or the network entity 105 to map the first subset of the set of coded bits to a matrix of entries associated with the first sub-band, where one or more rows of the matrix include a set of unavailable entries restricted from being mapped to based on the second modulation order being greater than the first modulation order.

In some examples, to support interleaving the first subset of the set of coded bits, the mapping component 735 may be configured to cause the UE 115 or the network entity 105 to map the second subset of the set of coded bits to a matrix of entries associated with the second sub-band, where one or more rows of the matrix include a set of unavailable entries restricted from being mapped to based on the first modulation order being greater than the second modulation order.

In some examples, interleaving the set of coded bits in accordance with the first rank being smaller than the second rank is based on rank being associated with a higher priority than modulation order.

In some examples, the mapping configuration is a first mapping configuration, and the configuration component 725 may be configured to cause the UE 115 or the network entity 105 to communicate control signaling indicative of a set of multiple mapping configurations including at least the first mapping configuration.

In some examples, the configuration component 725 may be configured to cause the UE 115 or the network entity 105 to communicate second control signaling indicative of the first mapping configuration from the set of multiple mapping configurations, where the set of code blocks associated with the single transport block being mapped to the set of sub-bands in accordance with the first mapping configuration is based on communication of the second control signaling.

In some examples, the configuration component 725 may be configured to cause the UE 115 or the network entity 105 to select the first mapping configuration from the set of multiple mapping configurations, where the set of code blocks associated with the single transport block being mapped to the set of sub-bands in accordance with the first mapping configuration is based on selection of the first mapping configuration.

By including or configuring a processing system 720 for operation in a processing system 720 as described herein, the processing system 720 may support techniques for mapping each CB, of a set of CBs associated with a single TB, to a set of sub-bands associated with an integrated spectrum channel when each sub-band (e.g., at least one sub-band) of the set of sub-bands is associated with a different modulation order, a different rank, or both, which may result in reduced processing, reduced power consumption, and more efficient utilization of communication resources, among other advantages.

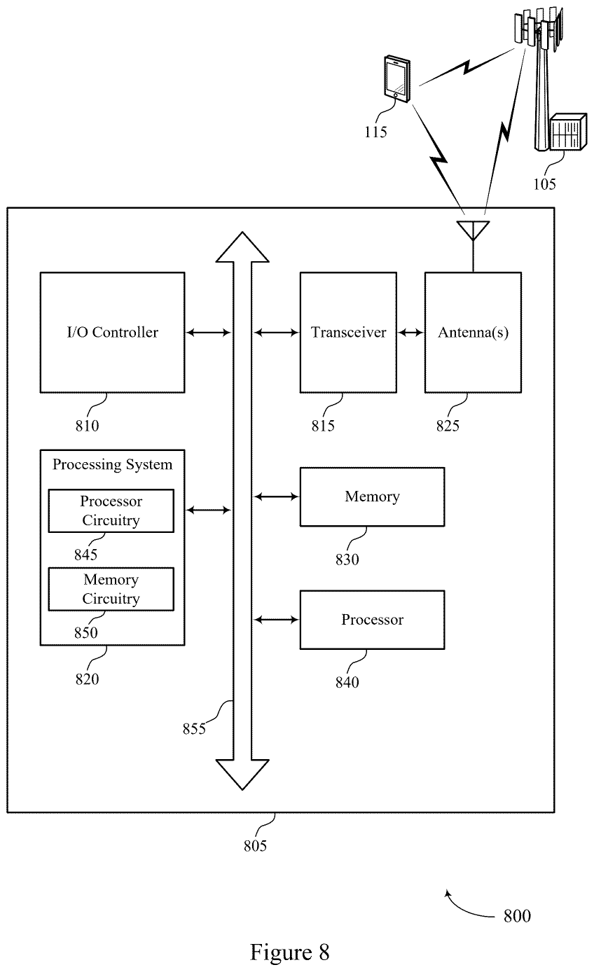

FIG. 8 shows an example of a system 800 including a device 805 that supports bit to constellation mapping for FSI. The device 805 may be an example of or include components of UE 115. The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

The processing system 820 may be an example of a processing system 140 or a processing system 700. For example, the processing system 820 may include processor circuitry 845 and memory circuitry 850 that stores code, and may be configured to cause the device 805 to perform operations that support bit to constellation mapping for FSI. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, may support techniques for bit to constellation mapping for FSI, which may result in improved communication reliability, reduced latency, improved user experience related to reduced processing, reduced power consumption, more efficient utilization of communication resources, improved coordination between devices, longer battery life, and improved utilization of processing capability, among other advantages.

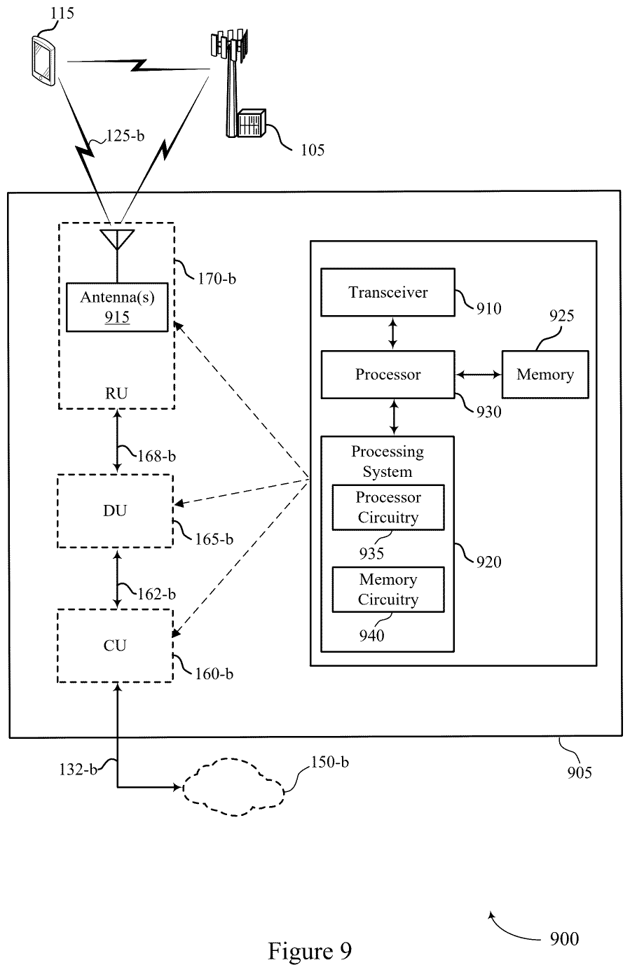

FIG. 9 shows an example of a system 900 including a device 905 that supports bit to constellation mapping for FSI. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 700. For example, the processing system 920 may include processor circuitry 935 and memory circuitry 940 that stores code, and the processing system 920 may be configured to cause the device 905 to perform operations that support bit to constellation mapping for FSI. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for mapping each CB, of a set of CBs associated with a single TB, to a set of sub-bands associated with an integrated spectrum channel when each sub-band (e.g., at least one sub-band) of the set of sub-bands is associated with a different modulation order, a different rank, or both, which may result in improved communication reliability, reduced latency, improved user experience related to reduced processing, reduced power consumption, more efficient utilization of communication resources, improved coordination between devices, longer battery life, and improved utilization of processing capability, among other advantages.

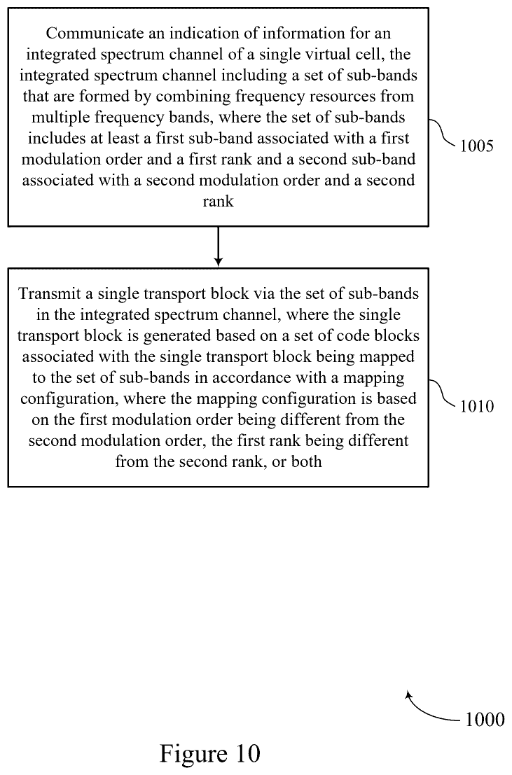

FIG. 10 shows an example of a method 1000 that supports bit to constellation mapping for FSI. Operations of the method 1000 may be performed by a UE 115 or a network entity 105 or respective components (such as using a processing system configured to cause the respective device to perform one or more of the operations), as described herein.

At 1005, the method may include communicating an indication of information for an integrated spectrum channel of a single virtual cell, the integrated spectrum channel including a set of sub-bands that are formed by combining frequency resources from multiple frequency bands, where the set of sub-bands includes at least a first sub-band associated with a first modulation order and a first rank and a second sub-band associated with a second modulation order and a second rank. In some examples, aspects of the operations of 1005 may be performed by a configuration component 725.

At 1010, the method may include transmitting a single transport block via the set of sub-bands in the integrated spectrum channel, where the single transport block is generated based on a set of code blocks associated with the single transport block being mapped to the set of sub-bands in accordance with a mapping configuration, where the mapping configuration is based on the first modulation order being different from the second modulation order, the first rank being different from the second rank, or both. In some examples, aspects of the operations of 1010 may be performed by an integrated spectrum component 730.

Implementation examples are described in the following numbered clauses:
Aspect 1: A method for wireless communications at a wireless device, comprising: communicating an indication of information for an integrated spectrum channel of a single virtual cell, the integrated spectrum channel comprising a set of sub-bands that are formed by combining frequency resources from multiple frequency bands, wherein the set of sub-bands comprises at least a first sub-band associated with a first modulation order and a first rank and a second sub-band associated with a second modulation order and a second rank; and transmitting a single transport block via the set of sub-bands in the integrated spectrum channel, wherein the single transport block is generated based at least in part on a set of code blocks associated with the single transport block being mapped to the set of sub-bands in accordance with a mapping configuration, wherein the mapping configuration is based at least in part on the first modulation order being different from the second modulation order, the first rank being different from the second rank, or both.
Aspect 2: The method of aspect 1, wherein the mapping configuration is based at least in part on the first modulation order being different from the second modulation order, the method further comprising: mapping a set of coded bits associated with a first code block of the set of code blocks to a set of ordered constellation bits across the first sub-band and the second sub-band, wherein the set of ordered constellation bits is based at least in part on a sequencing of a cumulative set of constellation bits from a most significant bit to a least significant bit, and wherein the cumulative set of constellation bits comprises one or more first constellation bits associated with the first modulation order and one or more second constellation bits associated with the second modulation order.
Aspect 3: The method of aspect 2, wherein a structure of the set of ordered constellation bits is based at least in part on a combination of the first modulation order and the second modulation order.
Aspect 4: The method of aspect 3, further comprising: communicating control signaling indicative of a table comprising associations between combinations of modulation orders and structures of a respective set of ordered constellation bits, wherein the table comprises an association between the combination of the first modulation order and the second modulation order and the structure of the set of ordered constellation bits.
Aspect 5: The method of any of aspects 1 through 4, wherein the mapping configuration is based at least in part on the first modulation order being different from the second modulation order, and wherein the first modulation order is greater than the second modulation order, the method further comprising: interleaving a set of coded bits associated with a first code block, of the set of code blocks, across the set of sub-bands based at least in part on ordering the first sub-band before the second sub-band in accordance with the first modulation order being greater than the second modulation order.
Aspect 6: The method of aspect 5, wherein interleaving the set of coded bits comprises: mapping the set of coded bits into a matrix of entries, wherein one or more rows of the matrix each comprise a set of unavailable entries restricted from being mapped to, wherein the set of unavailable entries are associated with the second sub-band based at least in part on the second modulation order being smaller than the first modulation order.
Aspect 7: The method of aspect 6, wherein the one or more rows comprise at least a first row of the matrix, and each row of the one or more rows comprise a set of available entries associated with the first sub-band and the set of unavailable entries associated with the second sub-band based at least in part on the first modulation order being greater than the second modulation order.
Aspect 8: The method of any of aspects 6 through 7, wherein interleaving the set of coded bits further comprises: refraining from interleaving the set of coded bits to the set of unavailable entries in each row of the one or more rows.
Aspect 9: The method of any of aspects 5 through 8, wherein interleaving the set of coded bits comprises mapping the set of coded bits into a matrix of entries, the method further comprising: puncturing a set of entries in each row of one or more rows of the matrix based at least in part on the first modulation order being greater than the second modulation order, wherein the set of entries are associated with the second sub-band based at least in part on the second modulation order being smaller than the first modulation order.
Aspect 10: The method of aspect 9, wherein the one or more rows comprise at least a first row of the matrix, each row of the one or more rows comprise a set of non-punctured entries associated with the first sub-band and the set of punctured entries associated with the second sub-band based at least in part on the first modulation order being greater than the second modulation order.
Aspect 11: The method of any of aspects 1 through 10, wherein the mapping configuration is based at least in part on the first rank being different from the second rank, and wherein the first rank is smaller than the second rank, the method further comprising: interleaving, for each code block of the set of code blocks, a first subset of a set of coded bits associated with a respective code block across the first sub-band in accordance with the first rank being smaller than the second rank; and interleaving, for each code block of the set of code blocks, a second subset of the set of coded bits across the second sub-band based at least in part on the first subset of the set of coded bits being interleaved across the first sub-band.
Aspect 12: The method of aspect 11, wherein the first modulation order is different from the second modulation order, and wherein interleaving the first subset of the set of coded bits comprises: mapping the first subset of the set of coded bits to a matrix of entries associated with the first sub-band, wherein one or more rows of the matrix comprise a set of unavailable entries restricted from being mapped to based at least in part on the second modulation order being greater than the first modulation order.
Aspect 13: The method of any of aspects 11 through 12, wherein the first modulation order is different from the second modulation order, and wherein interleaving the first subset of the set of coded bits comprises: mapping the second subset of the set of coded bits to a matrix of entries associated with the second sub-band, wherein one or more rows of the matrix comprise a set of unavailable entries restricted from being mapped to based at least in part on the first modulation order being greater than the second modulation order.

Aspect 14: The method of any of aspects 11 through 13, wherein interleaving the set of coded bits in accordance with the first rank being smaller than the second rank is based at least in part on rank being associated with a higher priority than modulation order.

Aspect 15: The method of any of aspects 1 through 14, wherein the mapping configuration is a first mapping configuration, the method further comprising: communicating control signaling indicative of a plurality of mapping configurations comprising at least the first mapping configuration.

Aspect 16: The method of aspect 15, further comprising: communicating second control signaling indicative of the first mapping configuration from the plurality of mapping configurations, wherein the set of code blocks associated with the single transport block being mapped to the set of sub-bands in accordance with the first mapping configuration is based at least in part on communication of the second control signaling.

Aspect 17: The method of any of aspects 15 through 16, further comprising: selecting the first mapping configuration from the plurality of mapping configurations, wherein the set of code blocks associated with the single transport block being mapped to the set of sub-bands in accordance with the first mapping configuration is based at least in part on selection of the first mapping configuration.

Aspect 18: A wireless device for wireless communications, comprising a processing system that includes processor circuitry and memory circuitry that stores code, the processing system configured to cause the wireless device to perform a method of any of aspects 1 through 17.

Aspect 19: A wireless device for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in “communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
communicate an indication of information for an integrated spectrum channel of a single virtual cell, the integrated spectrum channel comprising a set of sub-bands that are formed by combining frequency resources from multiple frequency bands, wherein the set of sub-bands comprises at least a first sub-band associated with a first modulation order and a first rank and a second sub-band associated with a second modulation order and a second rank; and
transmit a single transport block via the set of sub-bands in the integrated spectrum channel, wherein the single transport block is generated based at least in part on a set of code blocks associated with the single transport block being mapped to the set of sub-bands in accordance with a mapping configuration, wherein the mapping configuration is based at least in part on the first modulation order being different from the second modulation order, the first rank being different from the second rank, or both.

2. The wireless device of claim 1, wherein the mapping configuration is based at least in part on the first modulation order being different from the second modulation order, and the one or more processors are individually or collectively further operable to execute the code to cause the wireless device to:
map a set of coded bits associated with a first code block of the set of code blocks to a set of ordered constellation bits across the first sub-band and the second sub-band, wherein the set of ordered constellation bits is based at least in part on a sequencing of a cumulative set of constellation bits from a most significant bit to a least significant bit, and wherein the cumulative set of constellation bits comprises one or more first constellation bits associated with the first modulation order and one or more second constellation bits associated with the second modulation order.

3. The wireless device of claim 2, wherein a structure of the set of ordered constellation bits is based at least in part on a combination of the first modulation order and the second modulation order.

4. The wireless device of claim 3, wherein the one or more processors are individually or collectively further operable to execute the code to cause the wireless device to:
communicate control signaling indicative of a table comprising associations between combinations of modulation orders and structures of a respective set of ordered constellation bits, wherein the table comprises an association between the combination of the first modulation order and the second modulation order and the structure of the set of ordered constellation bits.

5. The wireless device of claim 1, wherein the mapping configuration is based at least in part on the first modulation order being different from the second modulation order, and the one or more processors are individually or collectively further operable to execute the code to cause the wireless device to:
interleave a set of coded bits associated with a first code block, of the set of code blocks, across the set of sub-bands based at least in part on ordering the first sub-band before the second sub-band in accordance with the first modulation order being greater than the second modulation order.

6. The wireless device of claim 5, wherein, to interleave the set of coded bits, the one or more processors are individually or collectively operable to execute the code to cause the wireless device to:
map the set of coded bits into a matrix of entries, wherein one or more rows of the matrix each comprise a set of unavailable entries restricted from being mapped to, wherein the set of unavailable entries are associated with the second sub-band based at least in part on the second modulation order being smaller than the first modulation order.

7. The wireless device of claim 6, wherein the one or more rows comprise at least a first row of the matrix, and wherein each row of the one or more rows comprise a set of available entries associated with the first sub-band and the set of unavailable entries associated with the second sub-band based at least in part on the first modulation order being greater than the second modulation order.

8. The wireless device of claim 6, wherein, to interleave the set of coded bits, the one or more processors are individually or collectively further operable to execute the code to cause the wireless device to:
refrain from interleaving the set of coded bits to the set of unavailable entries in each row of the one or more rows.

9. The wireless device of claim 5, wherein, to interleave the set of coded bits, the one or more processors are individually or collectively operable to execute the code to cause the wireless device to map the set of coded bits into a matrix of entries, and wherein the one or more processors are individually or collectively further operable to execute the code to cause the wireless device to:
puncture a set of entries in each row of one or more rows of the matrix based at least in part on the first modulation order being greater than the second modulation order, wherein the set of entries are associated with the second sub-band based at least in part on the second modulation order being smaller than the first modulation order.

10. The wireless device of claim 9, wherein the one or more rows comprise at least a first row of the matrix, wherein each row of the one or more rows comprise a set of non-punctured entries associated with the first sub-band and the set of punctured entries associated with the second sub-band based at least in part on the first modulation order being greater than the second modulation order.

11. The wireless device of claim 1, wherein the mapping configuration is based at least in part on the first rank being different from the second rank, and the one or more processors are individually or collectively further operable to execute the code to cause the wireless device to:
interleave, for each code block of the set of code blocks, a first subset of a set of coded bits associated with a respective code block across the first sub-band in accordance with the first rank being smaller than the second rank; and
interleave, for each code block of the set of code blocks, a second subset of the set of coded bits across the second sub-band based at least in part on the first subset of the set of coded bits being interleaved across the first sub-band.

12. The wireless device of claim 11, wherein, to interleave the first subset of the set of coded bits, the one or more processors are individually or collectively operable to execute the code to cause the wireless device to:
map the first subset of the set of coded bits to a matrix of entries associated with the first sub-band, wherein one or more rows of the matrix comprise a set of unavailable entries restricted from being mapped to based at least in part on the second modulation order being greater than the first modulation order.

13. The wireless device of claim 11, wherein, to interleave the first subset of the set of coded bits, the one or more processors are individually or collectively operable to execute the code to cause the wireless device to:
map the second subset of the set of coded bits to a matrix of entries associated with the second sub-band, wherein one or more rows of the matrix comprise a set of unavailable entries restricted from being mapped to based at least in part on the first modulation order being greater than the second modulation order.

14. The wireless device of claim 11, wherein interleaving the set of coded bits in accordance with the first rank being smaller than the second rank is based at least in part on rank being associated with a higher priority than modulation order.

15. The wireless device of claim 1, wherein the mapping configuration is a first mapping configuration, and the one or more processors are individually or collectively further operable to execute the code to cause the wireless device to:
communicate control signaling indicative of a plurality of mapping configurations comprising at least the first mapping configuration.

16. The wireless device of claim 15, wherein the one or more processors are individually or collectively further operable to execute the code to cause the wireless device to:
communicate second control signaling indicative of the first mapping configuration from the plurality of mapping configurations, wherein the set of code blocks associated with the single transport block being mapped to the set of sub-bands in accordance with the first mapping configuration is based at least in part on communication of the second control signaling.

17. The wireless device of claim 15, wherein the one or more processors are individually or collectively further operable to execute the code to cause the wireless device to:
select the first mapping configuration from the plurality of mapping configurations, wherein the set of code blocks associated with the single transport block being mapped to the set of sub-bands in accordance with the first mapping configuration is based at least in part on selection of the first mapping configuration.

18. A method for wireless communications at a wireless device, comprising:
communicating an indication of information for an integrated spectrum channel of a single virtual cell, the integrated spectrum channel comprising a set of sub-bands that are formed by combining frequency resources from multiple frequency bands, wherein the set of sub-bands comprises at least a first sub-band associated with a first modulation order and a first rank and a second sub-band associated with a second modulation order and a second rank; and
transmitting a single transport block via the set of sub-bands in the integrated spectrum channel, wherein the single transport block is generated based at least in part on a set of code blocks associated with the single transport block being mapped to the set of sub-bands in accordance with a mapping configuration, wherein the mapping configuration is based at least in part on the first modulation order being different from the second modulation order, the first rank being different from the second rank, or both.

19. The method of claim 18, wherein the mapping configuration is based at least in part on the first modulation order being different from the second modulation order, the method further comprising:
mapping a set of coded bits associated with a first code block of the set of code blocks to a set of ordered constellation bits across the first sub-band and the second sub-band, wherein the set of ordered constellation bits is based at least in part on a sequencing of a cumulative set of constellation bits from a most significant bit to a least significant bit, and wherein the cumulative set of constellation bits comprises one or more first constellation bits associated with the first modulation order and one or more second constellation bits associated with the second modulation order.

20. A wireless device for wireless communications, comprising:
means for communicating an indication of information for an integrated spectrum channel of a single virtual cell, the integrated spectrum channel comprising a set of sub-bands that are formed by combining frequency resources from multiple frequency bands, wherein the set of sub-bands comprises at least a first sub-band associated with a first modulation order and a first rank and a second sub-band associated with a second modulation order and a second rank; and
means for transmitting a single transport block via the set of sub-bands in the integrated spectrum channel, wherein the single transport block is generated based at least in part on a set of code blocks associated with the single transport block being mapped to the set of sub-bands in accordance with a mapping configuration, wherein the mapping configuration is based at least in part on the first modulation order being different from the second modulation order, the first rank being different from the second rank, or both.
